(19) United States
(12) Patent Application Publication
(10) Pub. No.: US 2009/0106001 A1
(43) Pub. Date: Apr. 23, 2009

(54) Digital I&C software failure simulation test facility

(75) Inventors: Yuan-Chang Yu, Taoyuan City (TW); Hong-Yih Yeh, Sindian City (TW); Hui-Wen Huang, Guishan Shiang (TW); Ming-Huei Chen, Bade City (TW)

Correspondence Address: TROXELL LAW OFFICE PLLC, 5205 LEESBURG PIKE, SUITE 1404, FALLS CHURCH, VA, 22041, US

(73) Assignee: ATOMIC ENERGY COUNCIL - INSTITUTE OF NUCLEAR ENERGY RESEARCH, Taoyuan (TW)

(21) Appl. No.: 11/907,751

(22) Filed: Oct. 17, 2007

(51) Int. Cl. G06G 7/48

(52) U.S. Cl. 703/6

(57) ABSTRACT

A test facility is obtained for software failure simulation. The test facility applies new failure modes related to software safety analysis and deduction. It is done by integrating a nuclear power plant simulation facility and a high pressure core flooder control facility. And the integration is done through a hardware I/O module and a quality guarantee network.

### FIELD OF THE INVENTION

The present invention relates to a test facility; more particularly, relates to providing applications of new failure modes related to software safety analysis and deduction.

### DESCRIPTION OF THE RELATED ART

When are a reactor of a common high pressure core flooder control facility encounters an emergency of water out-flow, an emergency core cooling system is activated automatically. At the time, because the high pressure core flooder control facility is designed to have a high output pressure, a water suction from a suppression pool or a condensate storage tank is immediately filled into a reactor before the reactor pressure is lowered. Then, water is supplied by an automatic depressurization system and a low pressure core flooder system to maintain a water level for ensuring cooling and avoiding over-heating of fuel core. These are the ideal operations of the high pressure core flooder control facility. In general, a test device is required for the high pressure core flooder control facility; and a test software is developed for the test device. Yet, once the test device is malfunctioned, the test software may be malfunctioned as well. Thus, damage may be expanded and response may be not good enough owing to short of overall considerations on nuclear safety and control. Hence, the prior art does not fulfill all users' requests on actual use.

### SUMMARY OF THE INVENTION

The main purpose of the present invention is to provide applications of new failure modes related to software safety analysis and deduction by integrating a nuclear power plant simulation facility and a high pressure core flooder control facility through a hardware input/output (I/O) module and a quality guarantee network.

To achieve the above purpose, the present invention is a digital instrument-and-control (I&C) software failure simulation test facility, comprising a nuclear power plant simulation facility having a software-based simulator; a controller comprising a high pressure core flooder controller and a simulation logic controller; and a graphic user control interface monitoring a high pressure core flooder control facility and an engineered safety features actuation control system, where applications of new failure modes related to software safety analysis and deduction are provided by integrating the nuclear power plant simulation facility and the high pressure core flooder control facility through a hardware I/O module and a quality guarantee network. Accordingly, a novel digital I&C software failure simulation test facility is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the structural view showing the preferred embodiment according to the present invention;

FIG. 2 is the structural view showing the nuclear power plant simulation facility;

FIG. 3 is the flow view showing the power plant simulation software;

FIG. 4 is the view showing the hardware design;

FIG. 5 is the view showing the high pressure core flooder system;

FIG. 6 is the view showing the graphic user control interface of the high pressure core flooder

FIG. 7 is the view showing the control logic of P-0001B; and

FIG. 8 is the view showing the GUI integration test module.

### DESCRIPTION OF THE PREFERRED EMBODIMENT

The following description of the preferred embodiment is provided to understand the features and the structures of the present invention.

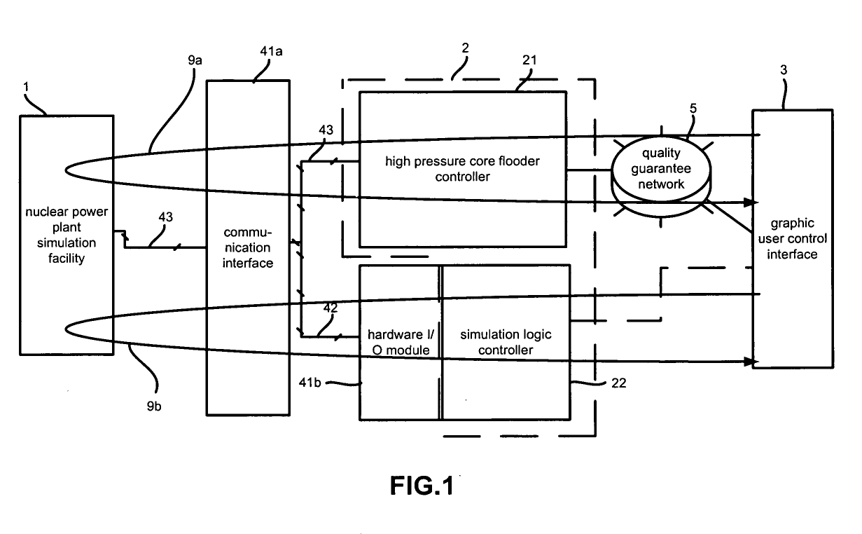

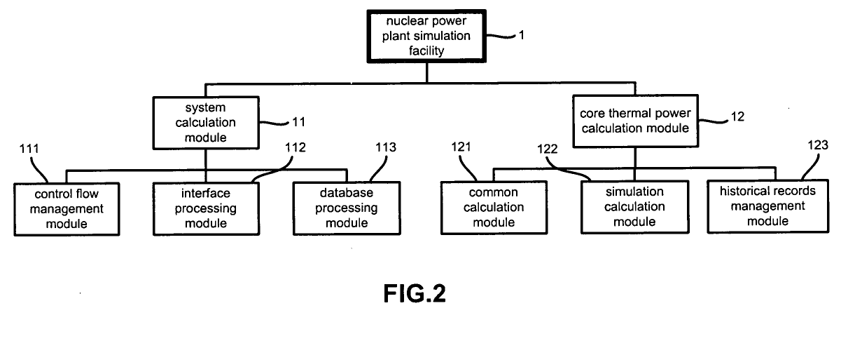

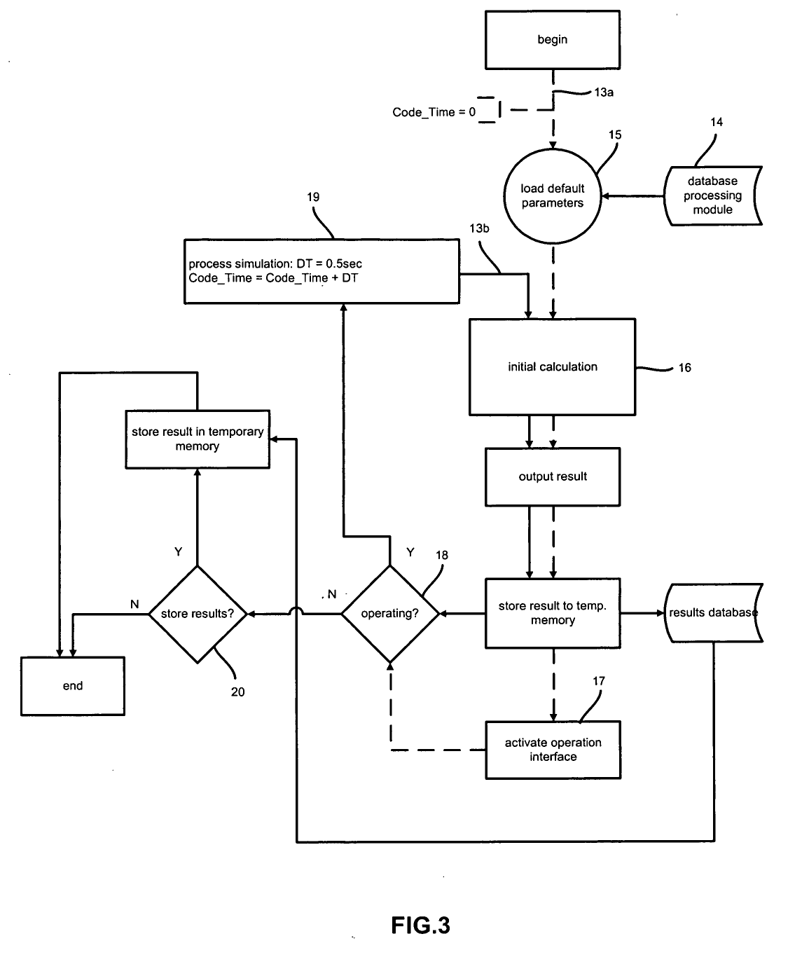

Please refer to FIG. 1 to FIG. 3, which are a structural view showing a preferred embodiment according to the present invention; a structural view showing a nuclear power plant simulation facility; and a flow view showing a power plant simulation software. As shown in the figures, the present invention is a digital instrument-and-control (I&C) software failure simulation test facility, comprising a nuclear power plant simulation facility 1, a controller 2 and a graphic user control interface 3, where new failure modes related to software safety analysis and deduction are applied

The nuclear power plant simulation facility 1 is a software-based simulator, comprising a system calculation module 11 and a core thermal power calculation module 12. The system calculation module 11 comprises a control flow management module 111, an interface processing module 112 and a database processing module 113. The core thermal power calculation module 12 comprises a common calculation module 121, a simulation calculation module 122 and simulation calculation module 122 and a historical records management module 123.

The controller 2 comprises a high pressure core flooder controller 21 and a simulation logic controller 22.

The graphic user control interface 3 monitors a high pressure core flooder control facility and an engineered safety features actuation control system.

The nuclear power plant simulation facility 1 and the controller 2 are connected through a communication interface of a hard-wired connection 42 and TCP/IP protocol 43; and the controller 2 and the graphic user control interface 3 are connected through a quality guarantee network 5.

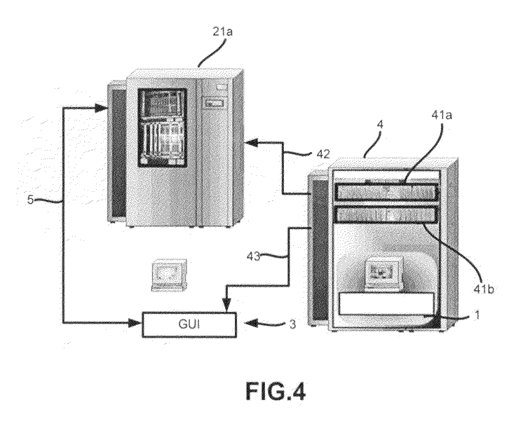

Please further refer to FIG. 4, which is a view showing a hardware design. As shown in the figure, a digital I&C software failure simulation test facility has two cabinets, which are a high pressure core flooder controller cabinet 21a containing a high pressure core flooder controller; and a second cabinet 4 containing communication interfaces 41a, 41b and the nuclear power plant simulation facility 1. And the graphic user control interface 3 is a simulation controller having a man-machine interface.

Through a combination of a dynamic link library (DLL) and the nuclear power plant simulation facility 1, data at hardware input/output (I/O) ends are accessed to link the nuclear power plant simulation facility 1 and a part of the simulation logic controller 22.

On processing a software simulation, two paths are obtained by the nuclear power plant simulation facility 1 for the software simulation, which are an initial software running path 13a and a routine software running path 13b. On running the software, default parameters are loaded 15 through the database processing module 14 for an initial calculation 16. Then an operation interface is activated 17 to finish the initial software running path 13a. On running the routine software running path 13b, an operation mode is decided 18 to process a calculation. The calculation contains some basic theological calculations using logic decisions in the initial calculation 16. On processing a simulation 19, a time base for a calculation is 500 milli-seconds (msec) and an interval between calculations is another 500 msec. After all calculations are finished, calculation results are asked whether to be stored or not 20.

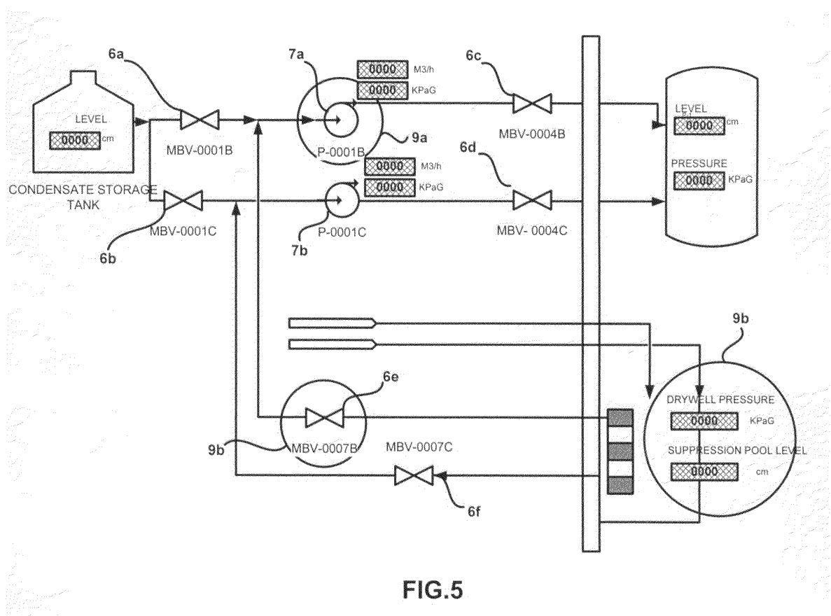

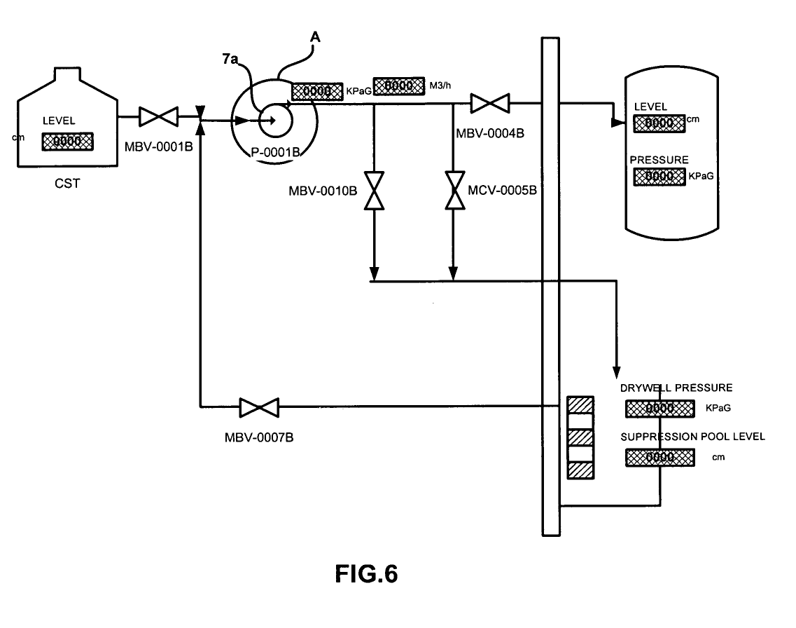

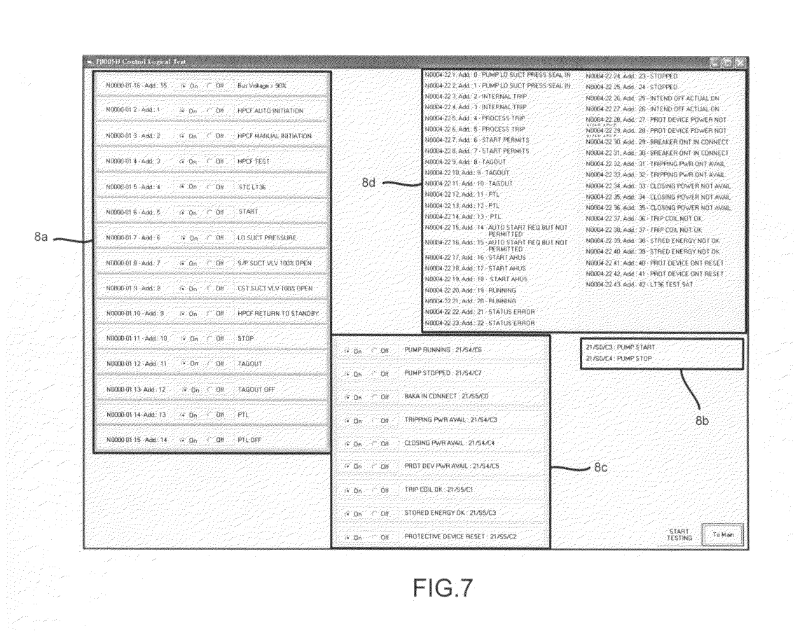

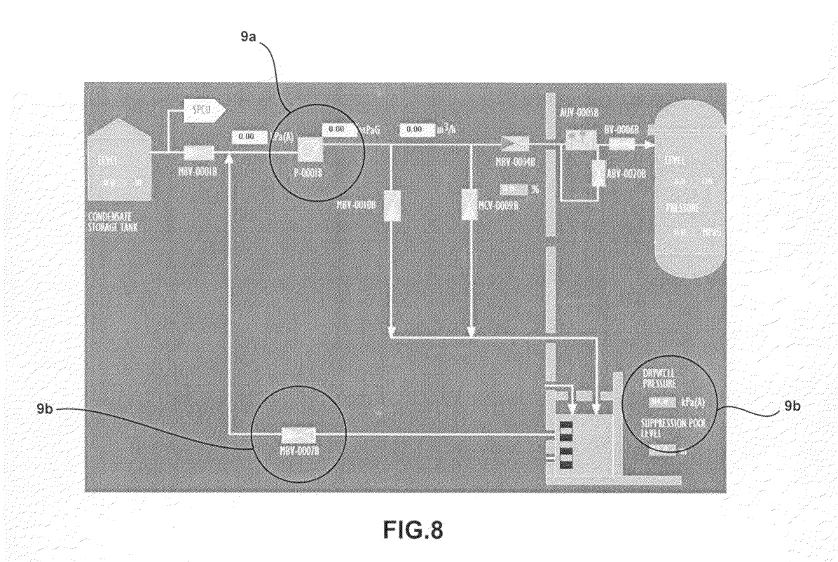

Please refer to FIG. 5 to FIG. 8, which are views showing a high pressure core flooder system, a graphic user control interface of the high pressure core flooder system, a control logic of P-0001B, and a GUI integration test module. As shown in the figures, a nuclear power plant simulation facility 1 simulates a high pressure core flooder control facility with a software. Control valves and pumps in main circles of B series and C series are provided, comprising an M-0001B control valve 6a, an M-0001C control valve 6b, a P-0001B control pump 7a, a P-0001C control pump 7b, an M-0004B control valve 6c, an M-0004C control valve 6d, an M-0007B control valve 6e and an M-0007C control valve 6f.

Take a graphic user control interface of a high pressure core flooder control facility in the B series as an example. The P-0001B control pump 7a is initially integrated in the system for developing a test software. Control logic areas of the high pressure core flooder control facility are corresponding to the test software for feeding data through a software input interface 8a and reading data from a software output interface 8b. Furthermore, an I/O module is provided to access a hardware output interface 8c and a hardware input interface 8d. With the above structure, the hardware of the high pressure core flooder control facility is setup and tested and the software for the hardware is tested too.

On testing an integration of the present invention which is shown in FIG. 1, the nuclear power plant simulation facility 1, a controller 2 and a graphic user control interface 3 are processed with two test loops. The first test loop 9a tests a linkage of the graphic user control interface 3, a high pressure core flooder controller 21 and the nuclear power plant simulation facility 1. And the second test loop 9b tests a linkage of the graphic user control interface 3, a simulation logic controller 22 and the nuclear power plant simulation facility 1.

As shown in FIG. 5 and FIG. 9, a test to the P-0001B control pump 7a covers the first test loop 9a; and the second test loop 9b is covered through a test to the M-0007B control valve 6e, where signals of a drywell pressure and signals of a water level of a suppression pool are returned from a power plant simulation software of the nuclear power plant simulation facility shown on the graphic user control interface 3.

On testing the P-0001B control pump 7a, a start button on the graphic user control interface 3 is pressed. Then a control valve corresponding to the high pressure core flooder control facility of the nuclear power plant simulation facility 1 is started. And then a start reaction is shown on the graphic user control interface 3. In the other hand, on testing the M-0007B control valve 6e, another start button on the graphic user control interface 3 is pressed. A control pump corresponding to the high pressure core flooder control facility of the nuclear power plant simulation facility 1 is started then. A start reaction is thus shown on the graphic user control interface 3. In this way, the integration of the nuclear power plant simulation facility 1 and the high pressure core flooder control facility is tested and shown. And data are thus transparent between the two systems through the hardware I/O module and a quality guarantee network to provide applications of new failure modes related to software safety analysis and deduction.

To sum up, the present invention is a digital I&C software failure simulation test facility, where a nuclear power plant simulation facility and a high pressure core flooder control facility are integrated through a hardware I/O module and a quality guarantee network to provide applications of new failure modes related to software safety analysis and deduction.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A digital instrument-and-control (I&C) software failure simulation test facility, comprising:
a nuclear power plant simulation facility, said nuclear power plant simulation facility having a software-based simulator;
a controller; and
a graphic user control interface, said graphic user control interface monitoring a high pressure core flooder control facility and an engineered safety features actuation control system.

2. The software failure simulation test facility according to claim 1,
wherein said nuclear power plant simulation facility has a system calculation module; and
wherein said system calculation module comprises a control flow management module, an interface processing module and a database processing module.

3. The software failure simulation test facility according to claim 1,
wherein said nuclear power plant simulation facility has a core thermal power calculation module; and
wherein said core thermal power calculation module comprises a common calculation module, a simulation calculation module and a historical records management module.

4. The software failure simulation test facility according to claim 1,
wherein said controller comprises a high pressure core flooder controller and a simulation logic controller.

5. The software failure simulation test facility according to claim 1,
wherein said nuclear power plant simulation facility and said controller are connected through a communication interface of a hard-wired connection and TCP/IP protocol; and
wherein said controller and said graphic user control interface are connected through a quality guarantee network.

6. The software failure simulation test facility according to claim 1,
wherein said software failure simulation test facility comprises a high pressure core flooder controller cabinet and a second cabinet.

7. The software failure simulation test facility according to claim 6,
wherein said high pressure core flooder controller cabinet contains a high pressure core flooder controller.

8. The software failure simulation test facility according to claim 6,
wherein said second cabinet contains communication interfaces and said nuclear power plant simulation facility.

9. The software failure simulation test facility according to claim 1,
wherein said graphic user control interface is a simulation controller having a man-machine interface.
